(19) United States
(12) Patent Application Publication
(10) Pub. No.: US 2020/0401505 A1
(43) Pub. Date: Dec. 24, 2020

(54) SYSTEM AND METHOD FOR AUTOMATED TESTING OF APPLICATION PROGRAM INTERFACE (API)

(71) Applicant: Wipro Limited, Bangalore (IN)

(72) Inventors: Gopinath Chenguttuvan, Sri Sakthi Nagar (IN); Vaishali Rajakumari, Tondairpet (IN)

(21) Appl. No.: 16/531,150

(22) Filed: Aug. 5, 2019

(30) Foreign Application Priority Data
Jun. 19, 2019 (IN) 201941024349

(51) Int. Cl. G06F 11/36; G06N 3/08

(52) U.S. Cl. CPC G06F 11/3688; G06F 11/3684; G06F 11/3676; G06N 3/08; G06F 11/3692

(57) ABSTRACT

The present invention relates to a method for automated testing of an Application Program Interface (API). A test requirement data is received to test an API from a first database. Further, the test requirement data is translated into a first set of vectors. Furthermore, one or more test scripts from a plurality of test scripts stored in a second database is selected based on output of the trained artificial neural network. The output indicative of a probability of effectiveness associated with the one or more test scripts is generated using the first set of vectors as inputs to a trained artificial neural network. The one or more test scripts are executed to test and validate the API.

### TECHNICAL FIELD

The present disclosure relates to the field of automated testing of Application Program Interface (API). Particularly, but not exclusively, the present disclosure relates to a neural network-based selection of test cases for automated testing of API.

### BACKGROUND

Generally, an Application Programming Interface (API) defines a functionality of a software application. An algorithm or rules required for functioning of the software application is embedded in the API. Therefore, it is necessary to test the API to ensure effective functioning of the software application. The API is tested by executing one or more test scripts comprising one or more test cases. Generally, in a manual testing, a testing engineer manually selects the one or more test scripts based on functionality of the software application to be tested. The selection of the one or more test scripts is done based on environment of using the software application, based on possible exception conditions, and alike parameters. The selection of the relevant one or more test scripts to test the API plays an important role in validating the functionalities of the API. However, it is a challenging task to replicate the intelligence of a testing engineer in an automated testing for selecting the one or more test scripts.

The existing automated testing techniques use same test scripts for testing different scenarios or new requirements of the API. This leads to lack of end to end coverage in testing the functionalities of the API.

An issue with the existing techniques is the lack of ability to select one or more test scripts for a new set of test requirements of the API, leading to the need of human intervention to select the one or more test scripts.

The information disclosed in this background of the disclosure section is only for enhancement of understanding of the general background of the invention and should not be taken as an acknowledgement or any form of suggestion that this information forms the prior art already known to a person skilled in the art.

### SUMMARY

One or more shortcomings of the prior art are overcome, and additional advantages are provided through the provision of method of the present disclosure.

Additional features and advantages are realized through the techniques of the present disclosure. Other embodiments and aspects of the disclosure are described in detail herein and are considered a part of the claimed disclosure.

Disclosed herein is a method for automated testing of an Application Program Interface (API). The method includes receiving a test requirement data to test an API from a first database. Further, the method includes translating the test requirement data into a first set of vectors. Furthermore, the method includes selecting one or more test scripts from a plurality of test scripts stored in a second database based on outputs generated using the first set of vectors provided as inputs to a trained artificial neural network, wherein the outputs are indicative of a probability of effectiveness associated with the one or more test scripts. Finally, the method includes executing the one or more test scripts to test and validate the API.

Embodiments of the present disclosure discloses an API testing system for automated testing of an Application Program Interface (API), the API testing system comprises a processor, and a memory communicatively coupled to the processor. The memory stores the processor-executable instructions, which, on execution, causes the processor to receive a test requirement data to test an API from a first database. Further, the processor is configured to translate the test requirement data into a first set of vectors. Furthermore, the processor is configured to select a one or more test scripts from a plurality of test scripts stored in a second database based on outputs generated using the first set of vectors provided as inputs to a trained artificial neural network, wherein the outputs are indicative of a probability of effectiveness associated with the one or more test scripts. Finally, the processor is configured to execute the one or more test scripts to test and validate the API.

Further, the present disclosure discloses a non-transitory computer readable medium including instructions stored thereon for automated testing of an Application Program Interface (API), that when processed by at least one processor cause a device to perform operations comprising, receiving a test requirement data to test an API from a first database. Further, translating the test requirement data into a first set of vectors. Furthermore, selecting one or more test scripts from a plurality of test scripts stored in a second database based on outputs generated using the first set of vectors provided as inputs to a trained artificial neural network, wherein the outputs are indicative of a probability of effectiveness associated with the one or more test scripts. Finally, executing the one or more test scripts to test and validate the API.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary system for testing an Application Program Interface (API), in accordance with some embodiments of the present disclosure;

FIG. 2 shows a detailed block diagram of an Application Program Interface (API) testing system, in accordance with some embodiments of the present disclosure;

FIG. 3 shows a flowchart illustrating method steps for testing an Application Program Interface (API), in accordance with some embodiment of the present disclosure;

FIG. 4 shows an exemplary artificial neural network architecture with one vector as input, in accordance with some embodiments of the present disclosure;

FIG. 5 shows an exemplary artificial neural network architecture with a first set of vectors as input, in accordance with some embodiments of the present disclosure; and

FIG. 6 shows an exemplary computer system for automated testing of an Application Program Interface (API), in accordance with some embodiments of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

The present disclosure describes a method for automated testing of an Application Program Interface (API). A test requirement data is received to test an API from a first database. Further, the test requirement data is translated into a first set of vectors to understand and analyze the test requirement data. The first set of vectors are provided to trained artificial neural network. Furthermore, one or more test scripts from a plurality of test scripts stored in a second database is selected based on an output of the trained artificial neural network. The output indicative of a probability of effectiveness associated with the one or more test scripts is generated using the first set of vectors as inputs to a trained artificial neural network. The one or more test scripts are executed to test and validate the API.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

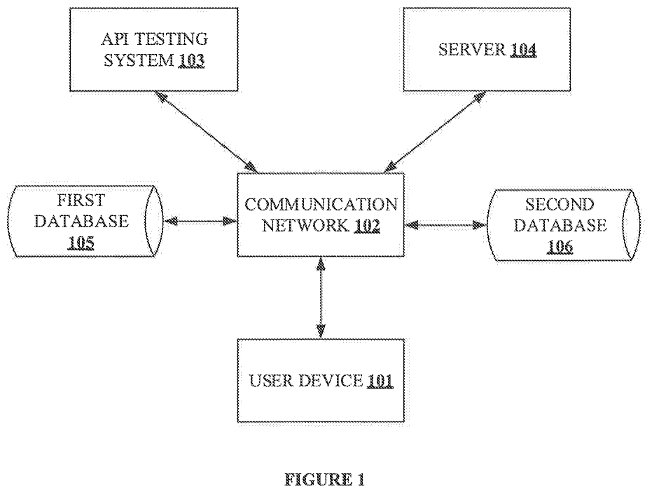

FIG. 1 shows an exemplary system for testing an Application Program Interface (API), in accordance with some embodiments of the present disclosure. A typical automated testing environment comprises a user device (101) operated by a user, communication network (102), an API testing system (103), a server (104), a first database (105), and a second database (106). The testing environment may comprise additional elements which are not illustrated in FIG. 1. FIG. 1 is illustrated with limited elements required to implement the aspects of the present disclosure.

In an embodiment, API enables communication and data exchange between two separate software systems. A software system implementing the API may contain functions or sub-routines which may be executed by another software system. The API testing system (103) may include one or more test scripts stored in the second database (106) connected to the communication network (102), for sending one or more software calls to the API, receiving an output of the API, and recording a response to the one or more software calls from the software system. The API testing system (103) may create at least one docker container in the server (104) for testing the API. The server (104) may be connected to the API testing system (103) via the communication network (102). The docker container may be a standardized container enabling a software application to run across one or more platforms. The docker container may be a lightweight, open platform technology enabling developers to build, ship, and run distributed software applications. The docker container may contain the necessary resources to run a software application and encapsulates services in isolated environments called containers. The docker container may allow user to create multiple isolated and secure environments within a single instance of an operating system. The docker container may enable API testing to be done across one or more platforms. Further, the API testing system (103) may install an API testing tool for example, a SoapUI tool in the docker container. An application for example, SoapUI may be required to interact with the API for sending the one or more software calls to the API and receiving the output of the API. The SoapUI tool may be capable of testing Simple Object Access Protocol (SOAP) and Representational State Transfer (REST) web services, Java Message Service (JMS), Action Message Format (AMF) and may perform Hyper Text Transfer Protocol (HTTP) calls. The SoapUI tool may store historic data of test reports generated for different testing scenarios and support one or more testing methods followed under Agile, Waterfall, and the like. The SoapUI tool may be capable of handling high volume and repeatable tasks. The tasks may include queries, calculations and maintenance of records, transactions, and the like. The SoapUI tool may enable testing of the API without missing or duplicating functionality issues, reliability issues, security issues, multi-threading issues, performance issues, and the like.

In an embodiment, the first database (105) may include test requirement data to test the API. The test requirement data may comprise one or more functionalities to be tested for an API. The one or more functionalities may be stored in a text format. The test requirement data may be selected based on the priority assigned to the one or more functionalities in the test requirement data. For example, the test requirement data may be a text as follows “Validate the log in and search functionalities of the web service”. In an embodiment, the priority to the one or more functionalities may be assigned by the user. Further, the user may store the new test requirement data along with the assigned priority in the first database.

In an embodiment, the second database (106) may include plurality of test scripts for testing the API. The plurality of test scripts may be stored in the second database (106) by the user. In one embodiment, the plurality of test scripts may be generated by the user. The plurality of test scripts may include one or more test scenarios for testing the API. A test scenario may be defined as a functionality of the API that can be tested. For example, consider an e-commerce software application, the one or more test scenarios may include checking login functionality for a user, checking search functionality, checking product description page, checking payments functionality, checking order history and the like. Further, each of the one or more test scenarios may include one or more test cases. A test case may be defined as a set of instructions or actions executed to verify a particular feature or functionality of the software application. For example, consider the login functionality test scenario for the e-commerce software application, the one or more test cases may include checking results on entering a valid user id and password, checking results on entering an invalid user id and password and checking a response upon not entering an user id (left empty) & a login button is pressed, and the like. Likewise, for another application such as an e-portal for maintaining data, the test scenarios like checking the login functionality, checking data description can be similar to the test scenarios for the e-commerce application. However, test scenarios such as payment functionality and order history may not be desired as such functionalities do not exist in the e-portal. However, conventional automated testing systems selects such undesired test scenarios.

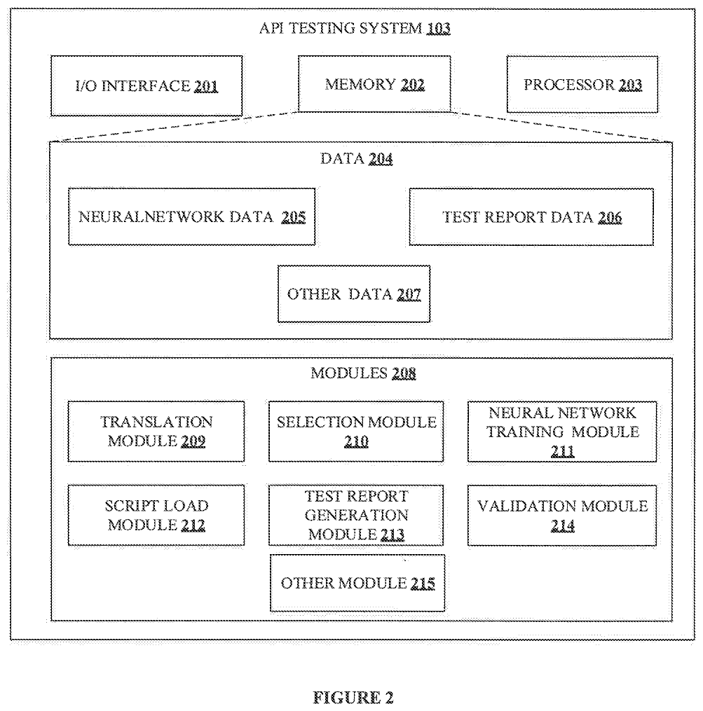

FIG. 2 shows a detailed block diagram of an Application Program Interface (API) testing system (103), in accordance with some embodiments of the present disclosure.

The API testing system (103) may include Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The API testing system (103) further includes an Input/Output (I/O) interface (201). The I/O interface (201) may be coupled with the processor (203) through which an input signal or/and an output signal may be communicated. In one embodiment, the API testing system (103) may receive the test requirement data and a plurality of test reports through the I/O interface (201).

In some implementations, the API testing system (103) may include data (204) and modules (208). As an example, the data (204) and modules (208) may be stored in the memory (202) configured in the API testing system (103) as shown in the FIG. 2. In one embodiment, the data (204) may include, for example, neural network data (205), test report data (206) and other data (207). In the illustrated FIG. 2, data (204) are described herein in detail.

In an embodiment, the neural network data (205) may include a plurality of weights between an input layer and one or more hidden layers and between the one or more hidden layers and an output layer. Further, the neural network data (205) may include an activation function data for example a softmax function which may be represented using the mathematical equation given below:

$$yi = \frac{{e}^{xi}}{{\sum }_{i = 0}^{n} {e}^{xi}} i = 0 , 1 , 2 … k \qquad ( 1 )$$

where yi indicates the output of the softmax function corresponding to the input element xi. The xi indicates each element of the input vector x. The input vector xi may be fed to the one or more hidden layers or the output layer of the artificial neural network. Further, k indicates the number of elements in the vector x. All the outputs yi of the softmax function may be stored as the vector y. For example, if the input vector x=[2 1 0.1] then the output vector y may be [0.7 0.2 0.1].

In an embodiment, the test report data (206) may include performance results of the tested API, execution status (success or failure), test execution statistics, and the like. The test execution statistics may include number of test cases executed, the number of test cases passed, the number of test cases failed, pass percentage of test cases, fail percentage of the test cases and the like. Further, the test report data (206) may include information for example total number of bugs, status of bugs (open, closed, responding), number of bugs in open status, resolved status and closed status and the like.

In an embodiment, the other data (207) may include update equations for the plurality of weights for the artificial neural network, format details to store the test report data (206) and selected one or more test scripts for testing the API.

In some embodiments, the data (204) may be stored in the memory (202) in form of various data structures. Additionally, the data (204) may be organized using data models, such as relational or hierarchical data models. The other data (207) may store data, including temporary data and temporary files, generated by the modules (208) for performing the various functions of the API testing system (103).

In some embodiments, the data (204) stored in the memory (202) may be processed by the modules (208) of the API testing system (103). The modules (208) may be stored within the memory (202). In an example, the modules (208) communicatively coupled to the processor (203) configured in the API testing system (103), may also be present outside the memory (202) as shown in FIG. 2 and implemented as hardware. As used herein, the term modules (208) may refer to an Application Specific Integrated Circuit (ASIC), a FPGA (Field Programmable Gate Array), an electronic circuit, a processor (203) (shared, dedicated, or group) and memory (202) that execute one or more software or firmware programs, a combinational logic circuit, and/or other suitable components that provide the described functionality. In some other embodiments, the modules (208) may be implemented using at least one of ASICs and FPGAs.

In one implementation, the modules (208) may include, for example, a translation module (209), a selection module (210), neural network training module (211), a script load module (212), a test report generation module (213), a validation module (214), and other module (215). It may be appreciated that such aforementioned modules (208) may be represented as a single module or a combination of different modules.

In an embodiment, the translation module (209) may be used to convert the test requirement data into first set of vectors. The test requirement data may be received in a text format. Initially, stop words in the test requirement data may be removed. The stop words may be one or more words which do not contribute to the context of the test requirement data or meaning of the test requirement data. For example, in English language the stop words may include “the”, “an”, “is”, “a”, “are”, “in” and the like. Further, the test requirement data may be converted into a vector using a word to vector model. Word to vector model may be a technique to represent a word in text format as vectors comprising numbers. In, an embodiment one-hot encoded vector may be used to represent the text in the test requirement data as a first set of binary vectors. The one hot encoded vector may include words in the test requirement data mapped as integer values and each integer value is represented as a first set of binary vectors that is all zero values except the index of the integer, which is marked with a 1. For example, consider a test requirement data “Check the Login Functionality of the website”. After the removal of stop words the test requirement data may be “Check login functionality website”. That means a total of 4 words in the test requirement data is identified, hence integer values of 1 for “Check”, 2 for “login”, 3 for “functionality” and 4 for “website” can be assigned. Further, a binary vector for each integer may be used to represent the text into a first set of vectors. Therefore, “Check” may be represented as [1 0 0 0], “login” is represented [0 1 0 0], “functionality” is represented as [0 0 1 0] and “website” is represented as [0 0 0 1]. Likewise, different word to vector models (frequency based, predictions based, and the like) can be used.

In an embodiment, the neural network training module (211) may be used to train the artificial neural network based on a supervised learning algorithm using contents of the first database (105) as input and contents of the second database (106) associated with the API testing system (103) as expected output. The training process may include providing a first set of vectors generated by translating the test requirement data stored in the first database (105) as an input to the artificial neural network and determining an error in the output generated by the artificial neural network by comparing with the expected or desired output. Based on the determined error and the type of supervised learning algorithm the plurality of weights associated with the artificial neural network may be modified or updated and may be stored in the neural network data (205). For example, let E denote the determined error of the artificial neural network and let back-propagation be the supervised learning algorithm for modifying the plurality of weights. Each weight (w) among the plurality of weights may be updated using the equation given below:

$$w = w - η * \frac{dE}{d w} \qquad ( 2 )$$

Where η denotes the learning rate of the artificial neural network,

$$\frac{dE}{dw}$$

denotes the gradient of the determined error. In an embodiment, the plurality of the weights may be updated multiple times for the first set of vectors generated by translating the test requirement data stored in the first database (105) as an input. Further, based on the execution status of the one or more test scripts, the artificial neural network may be trained.

In an embodiment, the selection module (210) may be used to provide the one or more vectors generated by the translation module (209) corresponding to the test requirement data as input to the artificial neural network. Further, the selection module (210) may select one or more test scripts from a plurality of test scripts stored in the second database (106) to test the API, based on the output generated by the artificial neural network. The outputs may be indicative of a probability of effectiveness associated with the one or more test scripts, e.g., the probability value may indicate which test script among the one or more test scripts is best suited for a specific API. The probability of effectiveness associated with the one or more test scripts may indicate testing the plurality of functionalities of the API with the relevant one or more test scenarios and detecting any faults or exceptions in the API. In an exemplary embodiment, the number of outputs generated by the artificial neural network may be equal to the number of test scripts stored in the second database (106). For example, let there be 5 test scripts stored in the database and let the output generated by the artificial neural network be [0.1 0.8 0.05 0.05]. The selection module (210) may select the second test script having the highest probability of 0.8 among the 5 test scripts stored in the second database (106) for testing the API.

In an embodiment, the script load module (212) may be used to retrieve the selected script from the second data via a communication network (102) and execute the selected script for testing the API. Further, execution may include implementing the instructions or action of the selected script in the API.

In an embodiment, the test report generation module (213) may include collecting the performance results of the tested API, test execution status, test execution statistics and the like. Further the collected information may be stored in the test report data (206).

In an embodiment, the validation module (214) may include comparing the results obtained from testing different functionalities of the API with the expected output. Further, the performance and validity of the one or more test scripts may be checked, and the one or more test script execution status may be provided to the neural network training module (211) to further train the artificial neural network.

In an embodiment, the other module (215) may be used to store the one or more test scripts in the second database (106) and retrieve one or more test requirement data from the first database (105). In an embodiment, the other module (215) can include an execution module configured to execute the selected script.

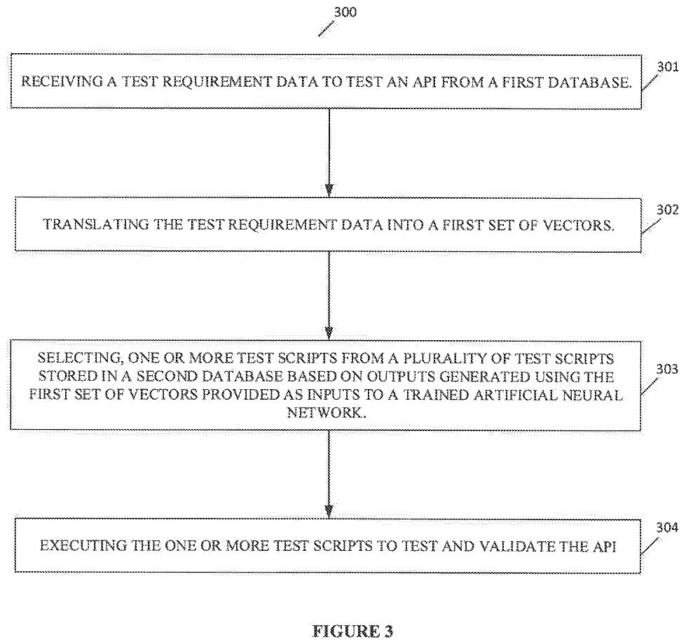

FIG. 3 shows a flowchart illustrating method automated testing of application program interface (API), in accordance with some embodiment of the present disclosure.

The order in which the method 300 may be described is not intended to be construed as a limitation, and any number of the described method blocks may be combined in any order to implement the method. Additionally, individual blocks may be deleted from the methods without departing from the scope of the subject matter described herein. Furthermore, the method may be implemented in any suitable hardware, software, firmware, or combination thereof.

At the step 301, the API testing system (103) may receive the test requirement data from the first database (105). The test requirement data may be received in the text format. The test requirement data may be received from the first database (105) via a communication network (102).

At the step 302, the test requirement data may be translated into a first set of vectors. The received test requirement data may be translated into the first set of vectors based on a word to vector model.

In an embodiment, the test requirement data in the text format may be used to remove the stop words and an integer number is assigned to the one or more words present in the test requirement data. In an exemplary embodiment, the integer number assigned to the one or more words may be converted into a vector of binary values including zeroes in the vector except for the index or the position of the word in the test requirement data to obtain the first set of vectors for each word present in the test requirement data.

At the step 303, one or more test scripts from the plurality of test scripts stored in the second database (106) may be selected based on the outputs generated by the trained artificial neural network. The artificial neural network may be provided with the first set of vectors as the input. Further, the artificial neural network may be trained based on a supervised learning algorithm using the first database (105) as input and the second database (106) associated with the API testing system (103) as expected output.

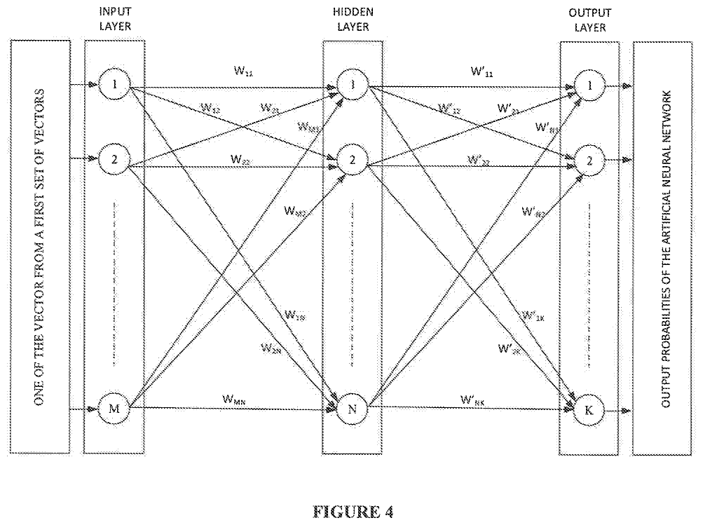

In an exemplary embodiment, the artificial neural network as shown in FIG. 4, may consist of a one input layer, one hidden layer and one output layer. In another embodiment, a plurality of hidden layers may be present in the artificial neural network. For the purpose of illustration, the present disclosure considers a single hidden layer. The input layer may be provided with first set of vectors as input. The number of neurons in the input layer may be equal to the number of values in the first set of vectors. The output of the input layer may be same as the input to the input layer using the identity function as the activation function, i.e., the input layer may receive the one or more vectors and forward the one or more vectors to the hidden layer. The output of the input layer may be provided an input to the hidden layer as the plurality of weights (denoted as W in general) as shown in FIG. 4. The activation function of the hidden layer neurons may be sigmoidal function given by the equation below:

$$z = \frac{1}{1 + {e}^{- b x}} \qquad ( 3 )$$

Where “z” indicates the output of each neuron in the hidden layer, “x” indicates the sum of all the inputs to each neuron in the hidden layer and “b” is a constant controlling the slope of the sigmoidal function. The number of neurons in the hidden layer may be set to a pre-determined value for example 8. Further, the output of the hidden layer neurons is fed as input to the output layer neurons via the plurality of weights (denoted as W′ in general) as shown in FIG. 4. The activation function of the neurons in the output layer may be the softmax function. The number of neurons in the output layer may be equal to number of one or more test scripts stored in the second database (106). The output of the output layer may be indicative of probability of effectiveness associated with the one or more test scripts. In an embodiment, the one or more test scripts having a probability greater than a threshold value for example 0.4, may be selected to test the API.

In an embodiment, the output of the output layer may be compared with the desired output and an error between the desired output and the output of the output layer may be computed. To minimize the error a supervised learning algorithm for example back propagation may be used to modify or update the plurality of weights (W and W′). Thus, the artificial neural network is trained for a plurality of test requirement data to enable a relevant selection of the one or more test scripts by increasing the probability of outputs generated by the output layer.

In an embodiment, a plurality of weights (W) may be generated for each of the first set of vectors obtained by translating the test requirement data stored in the first database (105).

For example, let one vector among the first set of vectors be A=[A₁ A₂ . . . A_{M}] having the dimension M×1. Let the number of neurons in the hidden layer be N, therefore the plurality of weights from the input layer to the hidden layer may be represented in the form of a matrix having a dimension M×N as shown below:

$$[ \begin{matrix}W 11 & W 12 & … & W 1 N \\ W 21 & W 22 & … & W 2 N \\ … & … & … & … \\ WM 1 & WM 2 & … & WMN\end{matrix} ]$$

The output of the hidden layer (denoted as Z) may be computed using the equations given below:

X=W^{T}*A (4)

and applying the sigmoidal activation function as given below:

$$Z = \frac{1}{1 + {e}^{- bX}} \qquad ( 5 )$$

Further, the Z may be a vector of dimension N×1 ([Z₁ Z₂ . . . Z_{N}]), and further applied as input to the output layer. Let the one or more scripts stored in the second database (106) be equal to “K”, therefore the plurality of weights (W′) from the hidden layer to the output layer having a dimension N×K in the matrix form is shown below:

$$[ \begin{matrix}{W }^{′} 11 & {W}^{′} 12 & … & {W}^{′} 1 N \\ {W}^{′} 21 & {W}^{′} 22 & … & {W}^{′} 2 N \\ … & … & … & … \\ {W}^{′} N 1 & {W}^{′} N 2 & … & {W}^{′} NK\end{matrix} ]$$

The output of the output layer (denoted as Y) may be computed using the equations given below:

U=W′^{T}*Z (6)

and applying the softmax activation function as given below:

$$Yi = \frac{{e}^{ui}}{{\sum }_{i = 0}^{n} {e}^{ui}} i = 0 , 1 , 2 … k \qquad ( 7 )$$

The output of the output layer Y ([Y₁ Y₂ . . . Y_{K}]) may be a vector of K×1 dimension. Each value in output vector Y denotes a probability of effectiveness associated with the corresponding one or more test scripts stored in the second database (106). The one or more test scripts having a probability greater than a threshold value may be selected to test the API. Therefore, the one or more test scripts may be selected based on the context of the test requirement data.

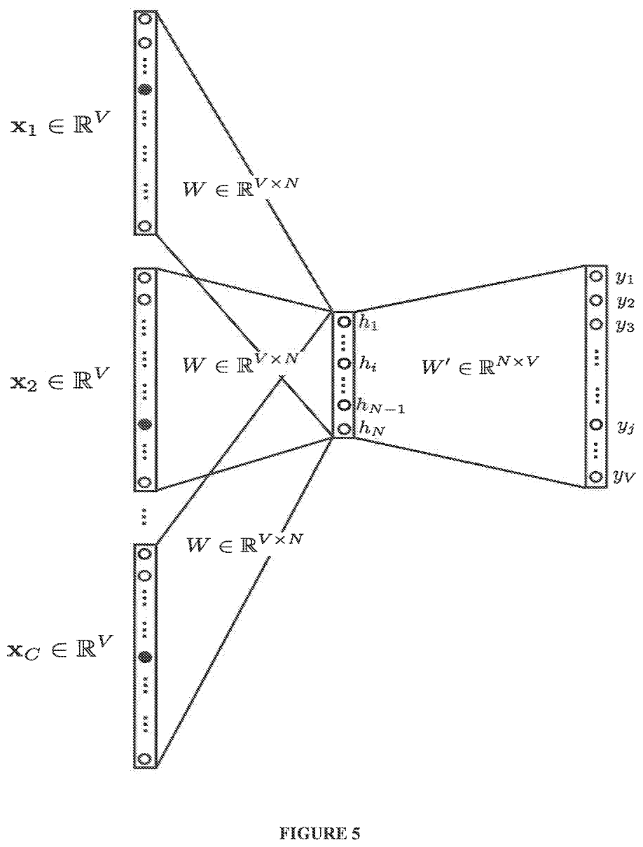

In an embodiment, more than one word from the set of first vectors may be used to select the one or more test scripts stored in the second database (106). The number of words from the first set of vectors may be used based on a predefined window size. The artificial neural network as shown in FIG. 5 may be used. For each vector (x₁, x₂, . . . , x_{c}) in the first set of vectors a trained set of plurality of weights (W) may be used to provide the input to the hidden layer as shown in FIG. 5. Further, the output of the hidden layer may be provided as input to the output layer via the plurality of weights (W′) to select the one or more scripts stored in the second database (106).

In an embodiment, the artificial neural network may be trained using the first set of vectors as inputs and the one or more test scripts as the desired outputs. For example, given a first set of vector A=[0 0 1 . . . 0] having a dimension M×1, the desired output may be first test script among the one or more test scripts stored in the database. Therefore, the desired output may be denoted as D=[1 0 0 . . . 0] having a dimension K×1. Let the output generated by the artificial neural network be Y=[Y₁ Y₂ . . . Y_{K}], an error (denoted as E) between the output generated by the artificial neural network and the desired output may be computed using the equation given below:

E=log(E(Y₁)+E(Y₂)+ . . . +E(Y_{K})) (8)

where E(Yᵢ) may be computed using the equation given below:

E(Yᵢ)=(log(e^{U1}+e^{U2}+ . . . +e^{UK})−U4) (9)

In an exemplary embodiment, the error E may be minimized using a gradient descent technique in the back-propagation algorithm by modifying the plurality of weights (W and W′) so that the accuracy of the output of the artificial neural network improves. To modify the plurality of weights (W and W′) the derivatives are computed and the plurality of weights (W and W′) are updated as shown below:

$$\begin{matrix}w = w - η * \frac{dE}{d w} & ( 10 ) \\ {w}^{′} = {w}^{′} - η * \frac{dE}{dw ′} & ( 11 )\end{matrix}$$

Where

$$\frac{dE}{d w} = A ⊗ ( {W}^{′} * E ) and \frac{dE}{dw ′} = ( {W}^{T} * X ) ⊗ E ,$$

⊕ denotes the outer product of the matrices.

At the step 304, the one or more test scripts may be executed to test and validate the API. The one or more test scripts may comprise one or more test scenarios. Further, the API may be validated by comparing a result of executing one or more test scenarios from the one or more test scripts with expected result.

In an embodiment, a plurality of test reports may be generated based on the validation of the API. The plurality of test reports comprises at least one of performance results of the tested API, test execution status, and test execution statistics.

In an embodiment, the plurality of generated test reports may be used to further train the artificial neural network.

### Computer System

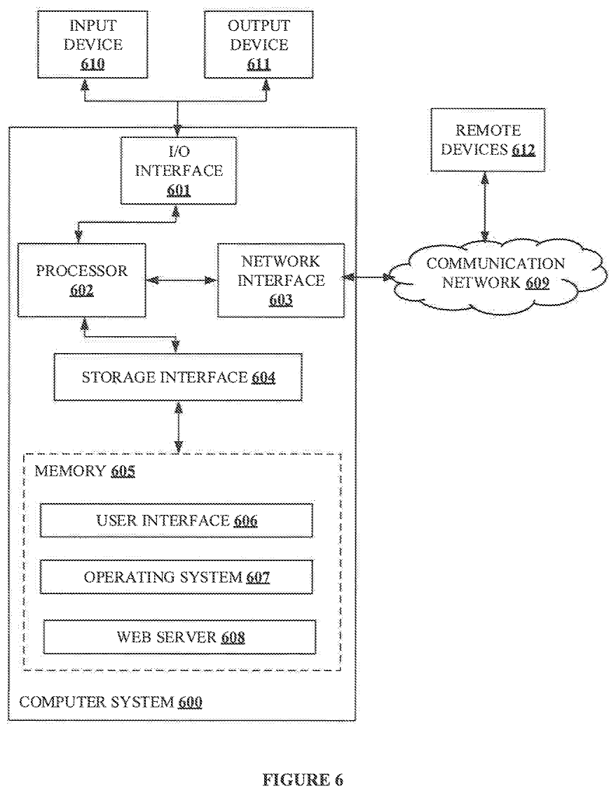

FIG. 6 illustrates a block diagram of an exemplary computer system (600) for implementing embodiments consistent with the present disclosure. In an embodiment, the computer system (600) may be used to implement the method for automated testing of an Application Program Interface (API). The computer system (600) may comprise a central processing unit (“CPU” or “processor”) (602). The processor (602) may comprise at least one data processor for executing program components for dynamic resource allocation at run time. The processor (602) may include specialized processing units such as integrated system (bus) controllers, memory management control units, floating point units, graphics processing units, digital signal processing units, etc.

The processor (602) may be disposed in communication with one or more input/output (I/O) devices (not shown) via I/O interface (601). The I/O interface (601) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (601), the computer system (600) may communicate with one or more I/O devices. For example, the input device (610) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (611) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (600) is connected to the service operator through a communication network (609). The processor (602) may be disposed in communication with the communication network (609) via a network interface (603). The network interface (603) may communicate with the communication network (609). The network interface (603) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (609) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (603) and the communication network (609), the computer system (600) may communicate with the one or more service operators.

In some embodiments, the processor (602) may be disposed in communication with a memory (605)(e.g., RAM, ROM, etc. not shown in FIG. 6 via a storage interface (604). The storage interface (604) may connect to memory (605) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (605) may store a collection of program or database components, including, without limitation, user interface (606), an operating system (607), web server (608) etc. In some embodiments, computer system (600) may store user/application data (606), such as the data, variables, records, etc. as described in this disclosure. Such databases may be implemented as fault-tolerant, relational, scalable, secure databases such as Oracle or Sybase.

The operating system (607) may facilitate resource management and operation of the computer system (600). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system (600) may implement a web browser (608) stored program component. The web browser (608) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers (608) may utilize facilities such as AJAX, HTML, ADOBE® FLASH®, JAVASCRIPT®, JAVA®, Application Programming Interfaces (APIs), etc. In some embodiments, the computer system (600) may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some embodiments, the computer system (600) may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processors to perform steps or stages consistent with the embodiments described herein. The term “computer-readable medium” should be understood to include tangible items and exclude carrier waves and transient signals, i.e., non-transitory. Examples include Random Access memory (RAM), Read-Only memory (ROM), volatile memory, non-volatile memory, hard drives, Compact Disc (CD) ROMs, Digital Video Disc (DVDs), flash drives, disks, and any other known physical storage media.

The automated testing of the API selects the one or more test scripts based on the context of the test requirement data. The automated testing of API may be used to select the one or more test scripts for a new test requirement data. Using one or more test scripts containing one or more test cases may be executed in multiple iterations saving time for repetitive tests. The automated testing of API may cover end to end coverage of the API testing.

Testing the API may be necessary to ensure effective functioning of the software application. The API may be tested by executing one or more test scripts comprising one or more test cases. The selection of the relevant one or more test scripts to test the API plays an important role in validating the functionalities of the API. The selection of the one or more test scripts from a plurality of test scripts stored in a second database (106) may be done based on the outputs generated using the first set of vectors provided as inputs to a trained artificial neural network. The outputs of the artificial neural network are indicative of a probability of effectiveness associated with the one or more test scripts. Further, the selection of the one or more test scripts may be done based on environment of using the software application, based on possible exception conditions, and alike parameters. The automated selection of the one or more test scripts may provide end to end coverage of testing and validating the one or more functionalities of the API.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

REFERRAL NUMERALS

| Reference number | Description |
|---|---|
| 101 | User Device |
| 102 | Communication Network |
| 103 | API testing system |
| 104 | Server |
| 105 | First Database |
| 106 | Second Database |
| 201 | I/O Interface |
| 202 | Memory |
| 203 | Processor |
| 204 | Data |
| 205 | Neural Network Data |
| 206 | Test Report Data |
| 207 | Other Data |
| 208 | Modules |
| 209 | Translation Module |
| 210 | Selection Module |
| 211 | Neural Network Training Module |
| 212 | Script Load Module |
| 213 | Test Report Generation Module |
| 214 | Validation Module |
| 215 | Other Module |
| 600 | Computer System |
| 601 | I/O interface |
| 602 | Processor |
| 603 | Network Interface |
| 604 | Storage Interface |
| 605 | Memory |
| 606 | User Interface |
| 607 | Operating System |
| 608 | Web Server |
| 609 | Communication Network |
| 610 | Input Device |
| 611 | Output Device |
| 612 | Remote Devices |

What is claimed is:

1. A method for automated testing of an Application Program Interface (API), the method comprising:
receiving, by an API testing system, a test requirement data to test an API from a first database;
translating, by the API testing system, the test requirement data into a first set of vectors;
selecting, by the API testing system, one or more test scripts from a plurality of test scripts stored in a second database based on outputs generated using the first set of vectors provided as inputs to a trained artificial neural network, wherein the outputs are indicative of a probability of effectiveness associated with the one or more test scripts; and
executing, by the API testing system, the one or more test scripts to test and validate the API.

2. The method of claim 1, wherein translating the received test requirement data into the first set of vectors is based on a word to vector model.

3. The method of claim 1, wherein the artificial neural network is trained based on a supervised learning algorithm using the first database as input and the second database associated with the API testing system as expected output.

4. The method of claim 1, wherein the one or more test scripts comprises one or more test scenarios.

5. The method of claim 1, wherein validating the API comprises comparing a result of executing one or more test scenarios from the one or more test scripts with expected result.

6. The method of claim 1 further comprising generating a plurality of test reports based on the validation of the API, wherein the plurality of test reports comprises at least one of performance results of the tested API, test execution status, and test execution statistics.

7. The method of claim 1, wherein the artificial neural network is further trained based on plurality of generated test reports.

8. An API testing system for automated testing of an Application Program Interface (API), the API testing system comprises:
a processor; and
a memory communicatively coupled to the processor, wherein the memory stores the processor executable instructions, which, on execution, causes the processor to:
receive a test requirement data to test an API from a first database;
translate the test requirement data into a first set of vectors;
select a one or more test scripts from a plurality of test scripts stored in a second database based on outputs generated using the first set of vectors provided as inputs to a trained artificial neural network, wherein the outputs are indicative of a probability of effectiveness associated with the one or more test scripts; and
execute the one or more test scripts to test and validate the API.

9. The API testing system of claim 8, wherein the processor is configured to translate the received test requirement data into the first set of vectors is based on a word to vector model.

10. The API testing system of claim 8, wherein the processor is configured to train the artificial neural network based on a supervised learning algorithm using the first database (105) as input and the second database (106) associated with the API testing system (103) as expected output.

11. The API testing system of claim 8, wherein the processor is configured to the one or more test scripts comprises one or more test scenarios.

12. The API testing system of claim 8, wherein the processor is configured to validate the API comprises comparing a result of executing one or more test scenarios from the one or more test scripts with expected result.

13. The API testing system of claim 8, wherein the processor is configured to generate a plurality of test reports based on the validation of the API, wherein the plurality of test reports comprises at least one of performance results of the tested API, test execution status, and test execution statistics.

14. The API testing system of claim 8, wherein the processor is configured to further train the artificial neural network based on plurality of generated test reports.

15. A non-transitory computer readable medium including instructions stored thereon for automated testing of an Application Program Interface (API), that when processed by at least one processor cause a device to perform operations comprising:
receiving a test requirement data to test an API from a first database;
translating the test requirement data into a first set of vectors;
selecting one or more test scripts from a plurality of test scripts stored in a second database based on outputs generated using the first set of vectors provided as inputs to a trained artificial neural network, wherein the outputs are indicative of a probability of effectiveness associated with the one or more test scripts; and
executing the one or more test scripts to test and validate the API.
